(19) United States
(12) Patent Application Publication
(10) Pub. No.: US 2024/0415153 A1
(43) Pub. Date: Dec. 19, 2024

(54) GANODERMA LUCIDUM COMPOUND PREPARATION, AND PREPARATION METHOD AND USE THEREOF

(71) Applicant: INNOVATION CENTER OF YANGTZE RIVER DELTA, ZJU, Jiaxing City (CN)

(72) Inventors: Guanchen LIU, Jiaxing City (CN); Haibo PAN, Jiaxing City (CN); Donghong LIU, Jiaxing City (CN); Shiguo CHEN, Jiaxing City (CN); Qihe CHEN, Jiaxing City (CN); Tian DING, Jiaxing City (CN); Wenjun WANG, Jiaxing City (CN); Enbo XU, Jiaxing City (CN); Shuang QIU, Jiaxing City (CN); Huan CHENG, Jiaxing City (CN)

(21) Appl. No.: 18/490,310

(22) Filed: Oct. 19, 2023

(30) Foreign Application Priority Data
Jun. 16, 2023 (CN) 2023107161554

(51) Int. Cl. A23L 2/38; A23L 5/30; A23L 29/238; A23L 29/256; A23L 29/269; A23L 31/00; A23L 33/125; A23L 33/16

(52) U.S. Cl. CPC A23L 2/38; A23L 5/32; A23L 29/238; A23L 29/256; A23L 29/269; A23L 31/00; A23L 33/125; A23L 33/16

(57) ABSTRACT

Provided are a Ganoderma lucidum compound preparation, and a preparation method and use thereof. The preparation method includes: mixing a superfine powder of a Ganoderma lucidumfruiting body, γ-cyclodextrin and a part of water to allow embedding to obtain a first feed liquid; mixing the first feed liquid with a composite colloid stabilizer solution to obtain a second feed liquid, a colloid stabilizer in the composite colloid stabilizer solution including at least three agar, guar gum, locust bean gum, carrageenan, and xanthan gum; mixing the second feed liquid with a metal ion solution to allow adjustment to acidic and shearing sequentially to obtain a third feed liquid, metal ions in the metal ion solution including iron ions, calcium ions, or zinc ions; and mixing the third feed liquid with remaining water, subjecting a resulting mixture to homogenization and heating sequentially to obtain the Ganoderma lucidum compound preparation.

### CROSS REFERENCE TO RELATED APPLICATION

This patent application claims the benefit and priority of Chinese Patent Application No. 2023107161554 filed with the China National Intellectual Property Administration on Jun. 16, 2023, and entitled “Ganoderma lucidum compound preparation, and preparation method and use thereof”, the disclosure of which is incorporated by reference herein in its entirety as part of the present application.

### TECHNICAL FIELD

The present disclosure relates to the technical field of food processing, in particular to a Ganoderma lucidum compound preparation, and a preparation method and use thereof.

### BACKGROUND

Ganoderma lucidum, as a traditional Chinese medicinal material as well as a medicinal fungus belonging to the Ganoderma, Polyporaceae, is widely distributed in temperate and subtropical regions of China. A large number of studies have shown that the Ganoderma lucidumhas various effects such as improving glucose and lipid metabolism, inhibiting tumor cell proliferation and differentiation, enhancing the body's immune function, and scavenging oxygen free radicals, and is widely used in the fields of functional foods, cosmetics, and medical supplies. At present, more than 150 functional components such as polysaccharides, volatile oils, triterpenes, alkaloids, proteins, polypeptides, and trace elements have been isolated from Ganoderma lucidumand identified. Commonly used parts of the Ganoderma lucidum include fruiting body and spore powder. Compared with the fruiting body, the spore powder contains more abundant active substances, but has less yield and high cost. The fruiting body shows a high yield and can be processed into Ganoderma lucidum products by traditional methods such as crushing, slicing, pressing, and boiling. The extract solution obtained from the fruiting body through hot water extraction is rich in polysaccharides and triterpenes, and the Ganoderma lucidum oral liquid produced after seasoning and compounding the same are currently the most important fruiting body products on the market. However, the hot water extraction has low efficiency and high level of residual active ingredients; moreover, dextran, a main component in the resulting extraction residue, is also proven to exhibit various physiological effects such as immune regulation, lipid lowering, and glucose reducing, thereby resulting in a waste of resources.

### SUMMARY

An object of the present disclosure is to provide a Ganoderma lucidum compound preparation, and a preparation method and use thereof. The Ganoderma lucidum compound preparation prepared by the method according to the present application could not only maintain active components of Ganoderma lucidum that are fully utilized, but also maintain a stability of a liquid product.

To achieve the above object, the present disclosure provides the following technical solutions:

Provided is a method for preparing a Ganoderma lucidum compound preparation, including the following steps:

mixing a superfine powder of a Ganoderma lucidum fruiting body, γ-cyclodextrin, and a part of water to allow embedding to obtain a first feed liquid;

mixing the first feed liquid with a composite colloid stabilizer solution to obtain a second feed liquid, wherein a colloid stabilizer in the composite colloid stabilizer solution includes at least three selected from the group consisting of agar, guar gum, locust bean gum, carrageenan, and xanthan gum;

mixing the second feed liquid with a metal ion solution to obtain a first mixture, and subjecting the first mixture to adjustment to acidic and shearing sequentially to obtain a third feed liquid, wherein metal ions in the metal ion solution include iron ions, calcium ions, or zinc ions; and

mixing the third feed liquid with remaining water to obtain a second mixture and subjecting the second mixture to homogenization and heating sequentially to obtain the Ganoderma lucidum compound preparation.

In some embodiments, the superfine powder of the Ganoderma lucidum fruiting body has an average particle size of 2 μm to 5 μm, and the Ganoderma lucidum compound preparation contains 3 wt % to 6 wt % of the superfine powder of the Ganoderma lucidum fruiting body.

In some embodiments, the Ganoderma lucidum compound preparation contains 0.1 wt % to 0.2 wt % of the γ-cyclodextrin.

In some embodiments, the embedding is conducted at a temperature of 50° C. to 60° C. for 40 min to 60 min under an ultrasonic treatment with an ultrasonic power of 300 W to 500 W.

In some embodiments, the Ganoderma lucidum compound preparation contains 0.21 wt % to 0.69 wt % of the colloid stabilizer.

In some embodiments, the metal ion solution is an aqueous solution of a food-grade metal salt additive; and the Ganoderma lucidum compound preparation contains 0.02 wt % to 0.04 wt % of the food-grade metal salt additive.

In some embodiments, the part of water accounts for 50% to 60% of a total volume of the Ganoderma lucidum compound preparation; and the adjustment to acidic refers to adjusting a pH value of the first mixture to 4.1 to 4.2.

In some embodiments, the shearing is conducted at a rotation speed of 3,000 rpm to 5,000 rpm for 15 min to 30 min;

the homogenization is conducted at a pressure of 20 MPa to 25 MPa for 5 min to 10 min; and

the heating is conducted at a temperature of 90° C. to 100° C. for 15 min to 30 min.

The present disclosure further provides a Ganoderma lucidum compound preparation prepared by the method as described in above technical solutions.

The present disclosure further provides use of the Ganoderma lucidum compound preparation for preparation of a Ganoderma lucidum health beverage.

The present disclosure provides a method for preparing a Ganoderma lucidum compound preparation, including the following steps: mixing a superfine powder of a Ganoderma lucidum fruiting body, γ-cyclodextrin, and a part of water to allow embedding to obtain a first feed liquid; mixing the first feed liquid with a composite colloid stabilizer solution to obtain a second feed liquid, wherein a colloid stabilizer in the composite colloid stabilizer solution includes at least three selected from the group consisting of agar, guar gum, locust bean gum, carrageenan, and xanthan gum; mixing the second feed liquid with a metal ion solution to obtain a first mixture, and subjecting the first mixture to adjustment to acidic and shearing sequentially to obtain a third feed liquid, wherein metal ions in the metal ion solution includes iron ions, calcium ions, or zinc ions; and mixing the third feed liquid with remaining water to obtain a second mixture, and subjecting the second mixture to homogenization and heating sequentially to obtain the Ganoderma lucidumcompound preparation. In the present disclosure, easily-dispersible natural polysaccharides (i.e., γ-cyclodextrin and colloid stabilizer) act with insoluble fibers, Ganoderma lucidumpolysaccharides, and triterpenes in the Ganoderma lucidum in a manner of microgel, embedding, and non-covalent binding, the problem of a poor stability of active ingredients from Ganoderma lucidum in liquid products thereby could be solved. In addition, the natural polysaccharides could provide a unique texture and flavor thereof, make up for the taste defects of Ganoderma lucidum, inhibit the release of ganoderic acid, and reduce the bitterness of Ganoderma lucidum powder. Specifically, the Ganoderma lucidum compound preparation is prepared from the superfine powder of Ganoderma lucidum fruiting body instead of a single component or extract thereof, thereby retaining the active ingredients of Ganoderma lucidum to the greatest extent. The γ-cyclodextrin is used to embed active ingredients in the superfine powder of the Ganoderma lucidum fruiting body, such that the active ingredients are embedded in a cavity of the γ-cyclodextrin, so as to achieve a protective effect. The composite colloid stabilizer could form a porous structure of a microgel texture during subsequent heating, thereby further protecting the active ingredients in Ganoderma lucidum and preventing the insoluble fibers from settling in the system. The addition of metal ions could further enhance acid resistance and heat resistance of the colloid, maintain a texture stability of the microgel formed by the composite colloid stabilizer, and retain the protective effect on the active ingredients of Ganoderma lucidum during storage. The method is simple in operations and has low cost, and the prepared product is convenient to carry and take; meanwhile, the preparation method is also beneficial to the subsequent research, development, and preparation of Ganoderma lucidum-related products (such as Ganoderma lucidum health beverages).

### DETAILED DESCRIPTION OF THE EMBODIMENTS

The present disclosure provides a method for preparing a Ganoderma lucidum compound preparation, including the following steps:

mixing a superfine powder of a Ganoderma lucidum fruiting body, γ-cyclodextrin, and a part of water to allow embedding to obtain a first feed liquid;

mixing the first feed liquid with a composite colloid stabilizer solution to obtain a second feed liquid, wherein a colloid stabilizer in the composite colloid stabilizer solution includes at least three selected from the group consisting of agar, guar gum, locust bean gum, carrageenan, and xanthan gum;

mixing the second feed liquid with a metal ion solution to obtain a first mixture, subjecting the first mixture to adjustment to acidic and shearing sequentially to obtain a third feed liquid, wherein metal ions in the metal ion solution include iron ions, calcium ions, or zinc ions; and

mixing the third feed liquid with remaining water to obtain a second mixture, subjecting the second mixture to homogenization and heating sequentially to obtain the Ganoderma lucidum compound preparation.

In the present disclosure, the Ganoderma lucidum compound preparation is prepared from the superfine powder of Ganoderma lucidum fruiting body instead of a single component or extract thereof, thereby retaining active ingredients of Ganoderma lucidum to the greatest extent. The superfine powder of Ganoderma lucidum fruiting body contains more insoluble fibers, and both Ganoderma lucidum polysaccharides and triterpenoids therein show thermal instability and easy oxidation, which make it difficult to apply all functional ingredients in liquid systems. Natural polysaccharides are biological macromolecules that are synthesized by organisms and located in the cell wall, intracellular areas, intercellular areas, and out of secretory cells. Non-covalent bonding such as hydrogen bonding and electrostatic bonding are prone to occur between natural polysaccharides. On one hand, natural polysaccharides could form a microgel structure to prevent the precipitation of insoluble Ganoderma lucidum fibers; on the other hand, the non-covalent bonding between natural polysaccharides and Ganoderma lucidum polysaccharides could improve the stability of Ganoderma lucidum polysaccharides, hind the oxidation of triterpenes, thereby maintaining functional activity. The natural polysaccharides could also undergo molecular stacking through chelation with metal ions, which could control the thickness and hardness of the microgel in the system, thereby meeting the requirements of different liquid systems for texture, mouthfeel, and processing technology. The γ-cyclodextrin, composite colloid stabilizer, and metal ions are to protect active ingredients of Ganoderma lucidum, and prevent insoluble fibers from settling in the system, so as to finally obtain the Ganoderma lucidum compound preparation with high content of active ingredients and desirable stability. The method according to the present disclosure will be described in detail below.

In the present disclosure, unless otherwise specified, all raw materials required for preparation are commercially available products well known to persons skilled in the art. In some embodiments, the water used is pure water.

In the present disclosure, a superfine powder of a Ganoderma lucidum fruiting body, γ-cyclodextrin, and a part of water are mixed to allow embedding to obtain a first feed liquid. In some embodiments, the superfine powder of the Ganoderma lucidum fruiting body is a superfine powder of a Ganoderma lucidum (Leyss. ex Fr.) Karst fruiting body. In some embodiments, the superfine powder of the Ganoderma lucidum fruiting body has an average particle size of 2 μm to 5 μm. In some embodiments, the Ganoderma lucidum compound preparation contains 3 wt % to 6 wt %, specifically 3 wt %, 4 wt %, 5 w1%, or 6 wt % of the superfine powder of the Ganoderma lucidum fruiting body. In some embodiments, the Ganoderma lucidum compound preparation contains 0.1 wt % to 0.2 wt %, specifically 0.1 wt %, 0.15 wt %, or 0.2 wt % of the γ-cyclodextrin. The γ-cyclodextrin is composed of eight glucose molecules and has a larger molecular cavity than that of α-cyclodextrin and β-cyclodextrin; this substance could cover large guest molecules, and has strong solubility and desirable embedding effect. In some embodiments, the part of water accounts for 50% to 60%, specifically 50%, 55%, or 60% of a total volume of the Ganoderma lucidum compound preparation.

In some embodiments of the present disclosure, the superfine powder of the Ganoderma lucidum fruiting body is dispersed in hot water and kept warm, and γ-cyclodextrin is then added to a resulting Ganoderma lucidum dispersion; the γ-cyclodextrin is dissolved therein by stirring, and a resulting mixture is subjected to the embedding. In some embodiments, a temperature of the hot water is in a range of 50° C. to 60° C., and preferably 55° C. to 60° C. In some embodiments, a concentration of the superfine powder of the Ganoderma lucidum fruiting body in the Ganoderma lucidum dispersion is in a range of 5.6 wt % to 9.1 wt %, and preferably 6.3 wt % to 7.7 wt %. In some embodiments, the stirring is conducted for 20 min to 30 min, and preferably 20 min to 25 min. In some embodiments, the embedding is conducted under an ultrasonic treatment. In some embodiments, the ultrasonic treatment is performed at an ultrasonic power of 300 W to 500 W. and preferably 300 W to 400 W. In some embodiments, the embedding is conducted at a temperature of 50° C. to 60° C., and preferably 55° C. to 60° C. In some embodiments, the embedding is conducted for 40 min to 60 min, and preferably 40 min to 50 min. In some embodiments, after the embedding is completed, an obtained system is filtered to obtain the first feed liquid. In some embodiments, the filtration is performed by using a 200-mesh mesh filter.

In the present disclosure, after obtaining the first feed liquid, the first feed liquid is mixed with a composite colloid stabilizer solution to obtain a second feed liquid. A colloid stabilizer in the composite colloid stabilizer solution includes at least three selected from the group consisting of agar, guar gum, locust bean gum, carrageenan, and xanthan gum, specifically, being a combination of the locust bean gum, the xanthan gum, and the carrageenan, or a combination of the agar, the guar gum, the locust bean gum, the xanthan gum, and the carrageenan. In some embodiments, under the condition that the colloid stabilizer is a combination of the locust bean gum, the xanthan gum, and the carrageenan, a mass ratio of the locust bean gum, the xanthan gum, and the carrageenan is in a range of (3-6):(2-4):(20-40), and preferably 6:4:30. In some embodiments, under the condition that the colloid stabilizer is a combination of the agar, the guar gum, the locust bean gum, the xanthan gum, and the carrageenan, a mass ratio of the agar, the guar gum, the locust bean gum, the xanthan gum, and the carrageenan is in a range of (1-3):(2-5):(5-25):(3-6):(10-30), and preferably (2-3):(2-4):(5-10):(5-6):(20-30), specifically 1:2: 5:3: 30.3:4:25:6:10, 3:2:10:3:20, or 2:2:5:6:30. In some embodiments, the Ganoderma lucidum compound preparation contains 0.21 wt % to 0.69 wt %, preferably 0.3 wt % to 0.5 wt %, more preferably 0.38 wt % to 0.48 wt %, and most preferably 0.41 wt % to 0.45 wt % of the colloid stabilizer. In some embodiments, the composite colloid stabilizer solution has a concentration of 2.4 wt % to 4.0 wt %, and preferably 2.6 wt % to 3.6 wt %.

In some embodiments of the present disclosure, the composite colloid stabilizer solution is obtained by dissolving the colloid stabilizer in water, preferably by mixing the colloid stabilizer with water, and stirring for dissolving to obtain the composite colloid stabilizer solution. In some embodiments, the water is room-temperature water. In some embodiments, the stirring is conducted for 30 min to 40 min, preferably 30 min to 35 min. In some embodiments, after the first feed liquid is mixed with the composite colloid stabilizer solution, subjecting a resulting mixture to a first stirring and a second stirring in sequence to obtain the second feed liquid. In some embodiments, the first stirring is conducted at room temperature. In some embodiments, the first stirring is conducted for 25 min to 35 min, and preferably 25 min to 30 min. In some embodiments, the second stirring is conducted at a temperature of 50° C. to 60° C. and preferably 50° C. to 55° C. In some embodiments. the second stirring is conducted for 20 min to 30 min, and preferably 25 min to 30 min.

In the present disclosure, after obtaining a second feed liquid, the second feed liquid is mixed with a metal ion solution to obtain the first mixture, and the first mixture is subjected to adjustment to acidic and shearing sequentially to obtain a third feed liquid. Metal ions in the metal ion solution include iron ions, calcium ions, or zinc ions, which are essential metal ions for human body. In some embodiments, the metal ion solution is an aqueous solution of a food-grade metal salt additive. In some embodiments, the food-grade metal salt additive is calcium gluconate, zinc gluconate, or ferric chloride. In the present disclosure, there is no special limitation on a concentration of the metal ion solution, as long as the food-grade metal salt additive could be fully dissolved. In some embodiments, the Ganoderma lucidum compound preparation contains 0.02 w1% to 0.04 wt %, specifically 0.02 wt %. 0.03 wt %, or 0.04 wt % of the food-grade metal salt additive. In some embodiments, an acid reagent used for the adjustment to acidic is an organic acid. In some embodiments, the organic acid includes citric acid, malic acid, or lactic acid. In some embodiments, the adjustment to acidic refers to adjusting the pH value of the system (i.e., the first mixture) to 4.1 to 4.2, and preferably to 4.2. In some embodiments, the pH value of the system (i.e., the first mixture) is adjusted to the above range to ensure an acidic environment, which reduces temperature and time required for sterilization of a product, thereby ensuring flavor and nutritional quality of the product. In some embodiments, taking citric acid as an example, the Ganoderma lucidum compound preparation contains 0.05 wt % to 0.1 wt %, and preferably 0.05 wt % to 0.07 wt % of the citric acid. In some embodiments, the shearing is conducted at a rotation speed of 3,000 rpm to 5,000 rpm, and preferably 3,000 rpm to 4,000 rpm. In some embodiments, the shearing is conducted for 15 min to 30 min, and preferably 20 min to 30 min. In some embodiments of the present disclosure, the shearing is conducted under the above conditions to quickly and uniformly disperse and mix components in the system, which is conducive to maintaining a suspension stability of the system and preventing system instability caused by local short-term high concentrations.

In the present disclosure, after obtaining the third feed liquid, the third feed liquid is mixed with remaining water to obtain the second mixture, and the second mixture is subjected to homogenization and heating sequentially to obtain the Ganoderma lucidum compound preparation. In some embodiments, after the third feed liquid is obtained, water (i.e., the remaining water) is replenished to the third feed liquid until contents of the aforementioned components are within a predetermined range. In some embodiments of the present disclosure, the third feed liquid and the remaining water are mixed by stirring. In some embodiments, the mixing by stirring is performed for 15 min to 25 min, and preferably 20 min. In some embodiments, the homogenization is conducted at a pressure of 20 MPa to 25 MPa. In some embodiments, the homogenization is conducted for 5 min to 10 min, and preferably 5 min to 7 min. In some embodiments, the homogenization is conducted under the above conditions, which could further reduce a particle size of the system and improve uniformity of mixing, which is conducive to maintaining system stability and desirable mouthfeel of the product. In some embodiments, the heating is conducted at a temperature of 90° C. to 100° C., and preferably 95° C. In some embodiments, the heating is conducted for 15 min to 30 min, and preferably 15 min to 20 min.

In the method of the present disclosure, the superfine powder of the Ganoderma lucidum fruiting body is used as a main body of the product, and active ingredients of Ganoderma lucidum are retained to the greatest extent. Meanwhile, a variety of natural polysaccharides are used to maintain and protect active ingredients of Ganoderma lucidum, without destroying the active ingredients of Ganoderma lucidum. Moreover, embedding and microgel in the preparation method are more conducive to the preservation of the active ingredients, thus ensuring no loss of nutrition and active ingredient content during product processing and shelf life.

The present disclosure further provides a Ganoderma lucidum compound preparation prepared by the method as described in the above technical solutions. In the present disclosure, the Ganoderma lucidum compound preparation has relatively high content of active ingredients and desirable stability.

The present disclosure further provides use of the Ganoderma lucidum compound preparation for preparation of a Ganoderma lucidum health beverage.

The technical solutions of the present disclosure will be clearly and completely described below in conjunction with the examples of the present disclosure. Apparently, the described examples are merely a part rather than all of the examples of the present disclosure. All other examples obtained by those skilled in the art based on the examples of the present disclosure without creative efforts shall fall within the scope of the present disclosure.

Among the raw materials used in the examples of the present disclosure, the superfine powder of the Ganoderma lucidum fruiting body is a superfine powder of a Ganoderma lucidum (Ley'ss. ex Fr.) Karst fruiting body (with an average particle size of 5 μm), and the water is pure water; while other raw materials are purchased commercially unless otherwise specified.

### EXAMPLES

### Example 1

In this example, a Ganoderma lucidum compound preparation was prepared from the following raw materials, in percentages by mass:

superfine powder of a Ganoderma lucidum fruiting body 3%, γ-cyclodextrin 0.1%, agar 0.01%, guar gum 0.02%, locust bean gum 0.05%, xanthan gum 0.03%, carrageenan 0.3%, calcium gluconate 0.02%, citric acid 0.05%, and water as a balance.

The Ganoderma lucidum compound preparation was prepared according to the following procedures:

S1: 30 g of the superfine powder of the Ganoderma lucidum fruiting body was dispersed in 500 mL of water at 50° C. and maintained at 50° C.; 1 g of the γ-cyclodextrin was then added thereto, and dissolved by stirring for 20 min. A resulting mixture was subjected to ultrasonic treatment at an ultrasonic power of 300 W for 40 min, and then filtered with a 200-mesh mesh filter, obtaining a first feed liquid.

S2: 4.1 g of a composite colloid stabilizer (a combination of agar, guar gum, locust bean gum, xanthan gum, and carrageenan) was mixed with 100 mL of room-temperature water (25° C.), and dissolved by stirring for 30 min, obtaining a composite colloid stabilizer solution. The composite colloid stabilizer solution was mixed with the first feed liquid, and a resulting mixture was stirred at room temperature for 30 min, then heated to 50° C. and stirred at 50° C. for 20 min, obtaining a second feed liquid.

S3: 200 mg of food-grade calcium gluconate was mixed with 50 mL of room-temperature water, obtaining a metal ion solution. The metal ion solution was added to the second feed liquid, and a pH value of a resulting system was adjusted to 4.2 with 0.5 g of citric acid. A resulting system was sheared at 3,000 rpm for 30 min, obtaining a third feed liquid.

S4: water was added to the third feed liquid until a total volume was 1,000 mL. A resulting system was mixed by stirring for 20 min, and then homogenized at 20 MPa for 5 min, obtaining a homogeneous solution. The homogeneous solution was heated to 95° C. and maintained at 95° C. for 15 min, and then aseptically canned and cooled in sequence, obtaining the Ganoderma lucidum compound preparation.

### Example 2

In this example, a Ganoderma lucidum compound was prepared from the following raw materials, in percentages by mass:

superfine powder of a Ganoderma lucidum fruiting body 4%, γ-cyclodextrin 0.15%, agar 0.03%, guar gum 0.04%, locust bean gum 0.25%, xanthan gum 0.06%, carrageenan 0.1%, zinc gluconate 0.03%, citric acid 0.07%, and water as a balance.

The Ganoderma lucidum compound preparation was prepared according to the following procedures:

S1: 40 g of the superfine powder of a Ganoderma lucidum fruiting body was dispersed in 600 mL of water at 60° C. and maintained at 60° C.; 1.5 g of the γ-cyclodextrin was then added thereto, and dissolved by stirring for 20 min. A resulting mixture was subjected to ultrasonic treatment at an ultrasonic power of 300 W for 50 min, and then filtered with a 200-mesh mesh filter, obtaining a first feed liquid.

S2: 4.8 g of a composite colloid stabilizer (a combination of agar, guar gum, locust bean gum, xanthan gum, and carrageenan) was mixed with 120 mL of room-temperature water, and dissolved by stirring for 40 min, obtaining a composite colloid stabilizer solution. The composite colloid stabilizer solution was mixed with the first feed liquid, and a resulting mixture was stirred at room temperature for 30 min, then heated to 60° C. and stirred at 60° C. for 20 min, obtaining a second feed liquid.

S3: 300 mg of food-grade zinc gluconate was mixed with 50 mL of room-temperature water, obtaining a metal ion solution. The resulting metal ion solution was added to the second feed liquid, and a pH value of a resulting system was adjusted to 4.2 with 0.7 g of citric acid. A resulting system was sheared at 4,000 rpm for 20 min, obtaining a third feed liquid.

S4: water was added to the third feed liquid until a total volume was 1,000 mL. A resulting system was mixed by stirring for 20 min, and then homogenized at 20 MPa for 7 min, obtaining a homogeneous solution. The homogeneous solution was heated to 95° C. and maintained at 95° C. for 15 min, and then aseptically canned and cooled in sequence, obtaining the Ganoderma lucidum compound preparation.

### Example 3

In this example, a Ganoderma lucidum compound preparation was prepared from the following raw materials, in percentages by mass:

superfine powder of a Ganoderma lucidum fruiting body 6%, γ-cyclodextrin 0.2%, agar 0.03%, guar gum 0.02%, locust bean gum 0.1%, xanthan gum 0.03%, carrageenan 0.2%, ferric chloride 0.03%, citric acid 0.1%, and water as a balance.

The Ganoderma lucidum compound preparation was prepared according to the following procedures:

S1: 60 g of the superfine powder of the Ganoderma lucidum fruiting body was dispersed in 600 mL of water at 60° C. and maintained at 60° C.; 2 g of the γ-cyclodextrin was then added thereto, and dissolved by stirring for 20 min. A resulting mixture was subjected to ultrasonic treatment at an ultrasonic power of 300 W for 60 min, and then filtered with a 200-mesh mesh filter, obtaining a first feed liquid.

S2: 3.8 g of a composite colloid stabilizer (a combination of agar, guar gum, locust bean gum, xanthan gum, and carrageenan) was mixed with 150 mL of room-temperature water, and dissolved by stirring for 40 min, obtaining a composite colloid stabilizer solution. The composite colloid stabilizer solution was mixed with the first feed liquid, and a resulting mixture was stirred at room temperature for 30 min, then heated to 60° C. and stirred at 60° C. for 30 min, obtaining a second feed liquid.

S3: 300 mg of food-grade ferric chloride was mixed with 50 ml of room-temperature water, obtaining a metal ion solution. The resulting metal ion solution was added to the second feed liquid, and a pH value of a resulting system was adjusted to 4.2 with 1 g of citric acid. A resulting system was sheared at 5,000 rpm for 15 min, obtaining a third feed liquid.

S4: water was added to the third feed liquid until a total volume was 1,000 mL. A resulting system was mixed by stirring for 20 min, and then homogenized at 25 MPa for 10 min, obtaining a homogeneous solution. The homogeneous solution was heated to 95° C. and maintained at 95° C. for 30 min, and then aseptically canned and cooled in sequence, obtaining the Ganoderma lucidum compound preparation.

### Example 4

In this example, a Ganoderma lucidum compound preparation was prepared from the following raw materials, in percentages by mass:

Superfine powder of a Ganoderma lucidum fruiting body 3%, γ-cyclodextrin 0.2%, agar 0.02%, guar gum 0.02%, locust bean gum 0.05%, xanthan gum 0.06%, carrageenan 0.3%, zinc gluconate 0.03%, citric acid 0.07%, and water as a balance.

The Ganoderma lucidum compound preparation was prepared according to the following procedures:

S1: 30 g of the superfine powder of the Ganoderma lucidum fruiting body was dispersed in 500 ml of water at 50° C. and maintained at 50° C.; 2 g of the γ-cyclodextrin was then added thereto, and dissolved by stirring for 20 min. A resulting mixture was subjected to ultrasonic treatment at an ultrasonic power of 300 W for 40 min, and then filtered with a 200-mesh mesh filter, obtaining a first feed liquid.

S2: 4.5 g of a composite colloid stabilizer (a combination of agar, guar gum, locust bean gum, xanthan gum, and carrageenan) was mixed with 120 mL of room-temperature water, and dissolved by stirring for 40 min, obtaining a composite colloid stabilizer solution. The composite colloid stabilizer solution was mixed with the first feed liquid, and a resulting mixture was stirred at room temperature for 30 min, then heated to 50° C. and stirred at 50° C. for 20 min, obtaining a second feed liquid.

S3: 300 mg of food-grade zinc gluconate was mixed with 50 mL room-temperature water, obtaining a metal ion solution. The resulting metal ion solution was added to the second feed liquid, and a pH value of a resulting system was adjusted to 4.2 with 0.7 g of citric acid. A resulting system was sheared at 3,000 rpm for 30 min, obtaining a third feed liquid.

S4: water was added to the third feed liquid until a total volume was 1,000 mL. A resulting system was mixed by stirring for 20 min, and then homogenized at 20 MPa for 5 min, obtaining a homogeneous solution. The homogeneous solution was heated to 95° C. and maintained at 95° C. for 20 min, and then aseptically canned and cooled in sequence, obtaining the Ganoderma lucidum compound preparation.

### Example 5

In this example, a Ganoderma lucidum compound preparation was prepared from the following raw materials, in percentages by mass:

Superfine powder of a Ganoderma lucidum fruiting body 5%, γ-cyclodextrin 0.15%, locust bean gum 0.06%, xanthan gum 0.04%, carrageenan 0.3%, ferric chloride 0.04%, citric acid 0.07%, and water as a balance.

The Ganoderma lucidum compound preparation was prepared according to the following procedures:

S1: 50 g of the superfine powder of the Ganoderma lucidum fruiting body was dispersed in 600 ml of water at 60° C. and maintained at 60° C.; 1.5 g of the γ-cyclodextrin was then added thereto, and dissolved by stirring for 30 min. A resulting mixture was subjected to ultrasonic treatment at an ultrasonic power of 300 W for 50 min, and then filtered with a 200-mesh mesh filter, obtaining a first feed liquid.

S2: 4 g of a composite colloid stabilizer (a combination of locust bean gum, xanthan gum, and carrageenan) was mixed with 150 mL of room-temperature water, and dissolved by stirring for 40 min, obtaining a composite colloid stabilizer solution. The composite colloid stabilizer solution was mixed with the first feed liquid, and a resulting mixture was stirred at room temperature for 30 min, then heated to 60° C. and stirred at 60° C. for 20 min, obtaining a second feed liquid.

S3: 400 mg of food-grade ferric chloride was mixed with 50 mL of room-temperature water, obtaining a metal ion solution. The resulting metal ion solution was added to the second feed liquid, and a pH value of a resulting system was adjusted to 4.2 with 0.7 g of citric acid. A resulting system was sheared at 5,000 rpm for 15 min, obtaining a third feed liquid.

S4: water was added to the third feed liquid until a total volume was 1,000 mL. A resulting system was mixed by stirring for 20 min, and then homogenized at 25 MPa for 10 min, obtaining a homogeneous solution. The homogeneous solution was heated to 95° C. and maintained at 95° C. for 30 min, and then aseptically canned and cooled in sequence, obtaining the Ganoderma lucidum compound preparation.

### Comparative Example 1

In this comparative example, a Ganoderma lucidum preparation was prepared from the following raw materials, in percentages by mass:

superfine powder of a Ganoderma lucidum fruiting body 3% and water as a balance.

The Ganoderma lucidum preparation was prepared from according to the following procedures:

S1: 30 g of the superfine powder of the Ganoderma lucidum fruiting body was dispersed in 500 mL of water at 50° C. and maintained at 50° C., dissolved by stirring for 20 min, and filtered with a 200-mesh mesh filter, obtaining a Ganoderma lucidum solution.

S2: water was added to the Ganoderma lucidum solution until a total volume was 1,000 mL. A resulting mixture was mixed by stirring for 20 min, and then homogenized at 20 MPa for 5 min, to obtaining a homogeneous solution. The homogeneous solution was heated to 95° C. and maintained at 95° C. for 15 min, and then aseptically canned and cooled in sequence, obtaining the Ganoderma lucidum preparation.

### Comparative Example 2

In this comparative example, a Ganoderma lucidum compound preparation was prepared from the following raw materials, having the formula as Example 1, in percentages by mass:

superfine powder of a Ganoderma lucidum fruiting body 3%, γ-cyclodextrin 0.1%, agar 0.01%, guar gum 0.02%, locust bean gum 0.05%, xanthan gum 0.03%, carrageenan 0.3%, calcium gluconate 0.02%, citric acid 0.05%, and water as a balance.

In this comparative example, the Ganoderma lucidum compound preparation was prepared according to the following procedures:

S1: 30 g of the superfine powder of the Ganoderma lucidum fruiting body was dispersed in 500 mL of water at 50° C., and filtered with a 200-mesh mesh filter, obtaining a first feed liquid.

S2: 4.1 g of a composite colloid stabilizer (a combination of agar, guar gum, locust bean gum, xanthan gum, and carrageenan) was mixed with 100 mL of room-temperature water, dissolved by stirring for 30 min, obtaining a composite colloid stabilizer solution. The composite colloid stabilizer solution was mixed with the first feed liquid. A resulting mixture was stirred at room temperature for 30 min, then heated to 50° C. and stirred at 50° C. for 20 min, obtaining a second feed liquid.

S3: 1 g of the γ-cyclodextrin was added to the second feed liquid, and dissolved by stirring for 20 min. A resulting system was subjected to ultrasonic treatment at an ultrasonic power of 300 W for 40 min, obtaining a third feed liquid.

S4: 200 mg of food-grade calcium gluconate was mixed with 50 mL of room-temperature water, obtaining a metal ion solution. The metal ion solution was added to the third feed liquid, and a pH value of a resulting system was adjusted to 4.2 with 0.5 g of citric acid. A resulting system was sheared at 3,000 rpm for 30 min, obtaining a fourth feed liquid.

S5: water was added to the fourth feed liquid until a total volume was 1,000 mL. A resulting system was mixed by stirring for 20 min, and then homogenized at 20 MPa for 5 min, obtaining a homogeneous solution. The homogeneous solution was heated to 95° C. and maintained at 95° C. for 15 min, and then aseptically canned and cooled in sequence, obtaining the Ganoderma lucidum compound preparation.

### Comparative Example 3

In this comparative example, a Ganoderma lucidum compound preparation was prepared from the following raw materials, having the same formula as Example 1, in percentages by mass:

superfine powder of a Ganoderma lucidum fruiting body 3%, γ-cyclodextrin 0.1%, agar 0.01%, guar gum 0.02%, locust bean gum 0.05%, xanthan gum 0.03%, carrageenan 0.3%, calcium gluconate 0.02%, citric acid 0.05%, and water as a balance.

In this comparative example, the Ganoderma lucidum compound preparation was prepared according to the following procedures:

S1: 30 g of the superfine powder of the Ganoderma lucidum fruiting body was dispersed in 500 ml of water at 50° C. and maintained at 50° C. 1 g of the γ-cyclodextrin was added thereto, and dissolved by stirring for 20 min. A resulting mixture was subjected to ultrasonic treatment at an ultrasonic power at 300 W for 40 min, and filtered with a 200-mesh mesh filter, obtaining a first feed liquid.

S2: 200 mg of food-grade calcium gluconate was mixed with 50 mL of room-temperature water, obtaining a metal ion solution. The metal ion solution was added to the first feed liquid, and a pH value of a resulting system was adjusted to 4.2 with 0.5 g of citric acid. A resulting system was sheared at 3,000 rpm for 30 min, obtaining a second feed liquid.

S3: 4.1 g of a composite colloid stabilizer (a combination of agar, guar gum, locust bean gum, xanthan gum, and carrageenan) was mixed with 100 mL of room-temperature water, and dissolved by stirring for 30 min, obtaining a composite colloid stabilizer solution. The composite colloid stabilizer solution was mixed with the second feed liquid. A resulting mixture was stirred at room temperature for 30 min, then heated to 50° C. and stirred at 50° C. for 20 min, obtaining a third feed liquid.

S4: water was added to the third feed liquid until a total volume was 1,000 mL. A resulting system was mixed by stirring for 20 min, and then homogenized at 20 MPa for 5 min, obtaining a homogeneous solution. The homogeneous solution was heated to 95° C. and maintained at 95° C. for 15 min, and then aseptically canned and cooled in sequence, obtaining the Ganoderma lucidum compound preparation.

### Comparative Example 4

In this comparative example, a Ganoderma lucidum compound preparation was prepared from the following raw materials (in percentages by mass), which omits the calcium gluconate on the basis of the raw material formula as described in Example 1:

superfine powder of a Ganoderma lucidum fruiting body 3%, γ-cyclodextrin 0.1%, agar 0.01%, guar gum 0.02%, locust bean gum 0.05%, xanthan gum 0.03%, carrageenan 0.3%, citric acid 0.05%, and water as a balance.

In this comparative example, the Ganoderma lucidum compound preparation was prepared according to the following procedures:

S1: 30 g of the superfine powder of the Ganoderma lucidum fruiting body was dispersed in 500 ml of water at 50° C. and maintained at 50° C. 1 g of the γ-cyclodextrin was then added thereto, and dissolved by stirring for 20 min. A resulting mixture was subjected to ultrasonic treatment at an ultrasonic power of 300 W for 30 min, and then filtered with a 200-mesh mesh filter, obtaining a first feed liquid.

S2: 4.1 g of a composite colloid stabilizer (a combination of agar, guar gum, locust bean gum, xanthan gum, and carrageenan) was mixed with 100 mL of room-temperature water, and dissolved by stirring for 30 min, obtaining a composite colloid stabilizer solution. The composite colloid stabilizer solution was mixed with the first feed liquid, and a resulting mixture was stirred at room temperature for 30 min, then heated to 50° C. and stirred at 50° C. for 20 min, obtaining a second feed liquid.

S3: A pH value of the second feed liquid was adjusted to 4.2 with 0.5 g of citric acid. A resulting mixture was sheared at 3,000 rpm for 30 min, obtaining a third feed liquid.

S4: water was added to the third feed liquid until a total volume was 1,000 mL. A resulting mixture was mixed by stirring for 20 min, and then homogenized at 20 MPa for 5 min, obtaining a homogeneous solution. The homogeneous solution was heated to 95° C. and maintained at 95° C. for 15 min, and then aseptically canned and cooled in sequence, obtaining the Ganoderma lucidum compound preparation.

### Comparative Example 5

In this comparative example, a Ganoderma lucidum compound preparation was prepared from the following raw materials (in percentages by mass), which omits the γ-cyclodextrin on the basis of the raw material formula as described in Example 1:

superfine powder of a Ganoderma lucidum fruiting body 3%, agar 0.01%, guar gum 0.02%, locust bean gum 0.05%, xanthan gum 0.03%, carrageenan 0.3%, calcium gluconate 0.02%, citric acid 0.05%, and water as a balance.

In this comparative example, the Ganoderma lucidum compound preparation was prepared according to the following procedures:

S1: 30 g of the superfine powder of the Ganoderma lucidum fruiting body was dispersed in 500 ml of water at 50° C. A resulting mixture was stirred for 20 min, and filtered with a 200-mesh mesh filter, obtaining a first feed liquid.

S2: 4.1 g of a composite colloid stabilizer (a combination of agar, guar gum, locust bean gum, xanthan gum, and carrageenan) was mixed with 100 mL of room-temperature water, and dissolved by stirring for 30 min, obtaining a composite colloid stabilizer solution. The composite colloid stabilizer solution was mixed with the first feed liquid, and a resulting mixture was stirred at room temperature for 30 min, then heated to 50° C. and stirred at 50° C. for 20 min, obtaining a second feed liquid.

S3: 200 mg of food-grade calcium gluconate was mixed with 50 mL of room-temperature water, obtaining a metal ion solution. The metal ion solution was added to the second feed liquid, and a pH value of a resulting system was adjusted to 4.2 with 0.5 g of citric acid. A resulting mixture was sheared at 3,000 rpm for 30 min, obtaining a third feed liquid.

S4: water was added to the third feed liquid until a total volume was 1,000 mL. A resulting system was mixed by stirring for 20 min, and then homogenized at 20 MPa for 5 min, obtaining homogeneous solution. The homogeneous solution was heated to 95° C. and maintained at 95° C. for 15 min, and then aseptically canned and cooled in sequence, obtaining the Ganoderma lucidum compound preparation.

### Test Example 1

The contents of active ingredients in the Ganoderma lucidum preparations prepared in examples and comparative examples were tested, the active ingredients referring to Ganoderma lucidum polysaccharides, triterpenes, and sterols. The Ganoderma lucidum preparations prepared in examples and comparative examples were used as solution samples; the freshly-prepared solution samples and the solution samples stored at 37° C. for 3 months after preparation were tested according to a method in the item of Ganoderma lucidum from “Chinese Pharmacopoeia (2015 Edition Part One)”. The specific results are shown in Table 1 (the contents of active ingredients were expressed as mass fraction relative to unit mass of superfine powder of a Ganoderma lucidum fruiting body used in the Ganoderma lucidum preparations).

TABLE 1
Contents of active ingredients in Ganoderma lucidum preparations
prepared in examples and comparative examples

| | | | Solution samples stored | |
|---|---|---|---|---|
| | Freshly-prepared | | at 37° C. for 3 | |
| | solution samples | | months after preparation | |
| | Ganoderma | | Ganoderma | |
| | lucidum | Contents of | lucidum | Contents of |
| | polysaccha- | triterpene | polysaccha- | triterpene |
| Source of | ride content | and sterol | ride content | and sterol |
| samples | (wt %) | (wt %) | (wt %) | (wt %) |
| Example 1 | 0.795 | 0.534 | 0.703 | 0.421 |
| Example 2 | 0.781 | 0.517 | 0.711 | 0.394 |
| Example 3 | 0.752 | 0.499 | 0.682 | 0.386 |
| Example 4 | 0.820 | 0.563 | 0.733 | 0.455 |
| Example 5 | 0.746 | 0.501 | 0.625 | 0.400 |
| Comparative | 0.625 | 0.421 | 0.403 | 0.239 |
| Example 1 | | | | |
| Comparative | 0.707 | 0.478 | 0.581 | 0.369 |
| Example 2 | | | | |
| Comparative | 0.693 | 0.469 | 0.577 | 0.352 |
| Example 3 | | | | |
| Comparative | 0.639 | 0.451 | 0.429 | 0.254 |
| Example 4 | | | | |
| Comparative | 0.735 | 0.495 | 0.623 | 0.384 |
| Example 5 | | | | |

As can be seen from the data in Table 1, the contents of active ingredients in the Ganoderma lucidum compound preparation prepared by the method according to the present disclosure are higher than those of the Ganoderma lucidum preparations prepared in comparative examples. This is mainly because the embedding and microgel processes during the preparation are conducive to the stable preservation of active ingredients, thereby improving the nutritional and active value of the product. Moreover, different processing sequences and steps also show an important impact on the contents of active ingredients in the product. In the present disclosure, γ-cyclodextrin is used to embed the active ingredients; natural polysaccharide colloids are used for outer microgel treatment; and the introduction of metal ions enhances acid resistance and heat resistance of the microgel, to achieve the best protection effect. The change of the sequence of treatment steps or the omitting of certain treatment step(s) would lead to a worse overall protection effect.

### Test Example 2

The Ganoderma lucidum preparations prepared by examples and comparative examples were used as solution samples; 50 mL of the freshly-prepared solution samples and 50 mL of the solution samples stored at 37°° C. for 3 months after preparation were separately centrifuged at 4,000 r/min for 20 min; supernatants were discarded, and a remaining material was dried at 60° C. until a weight thereof was not changed. A resulting bottom precipitate was weighed. The above test was repeated 3 times for each solution sample, and results were averaged. The precipitation coefficient was calculated. The results are shown in Table 2. The precipitation coefficient was calculated according to the following Equation:

Precipitation coefficient (%)=mass of precipitate (g)/mass of 50 mL solution sample (g)×100%.

TABLE 2
Results of centrifugation and precipitation of Ganoderma lucidum
preparations prepared in examples and comparative examples

| | Precipitation coefficient (%) | |
|---|---|---|
| Source of | Freshly-prepared | Solution samples stored at 37° C. |
| sample | solution samples | for 3 months after preparation |
| Example 1 | 0.10 | 0.20 |
| Example 2 | 0.10 | 0.20 |
| Example 3 | 0.15 | 0.25 |
| Example 4 | 0.10 | 0.20 |
| Example 5 | 0.15 | 0.25 |
| Comparative | 0.50 | 1.00 |
| Example 1 | | |
| Comparative | 0.20 | 0.30 |
| Example 2 | | |
| Comparative | 0.20 | 0.30 |
| Example 3 | | |
| Comparative | 0.35 | 0.60 |
| Example 4 | | |
| Comparative | 0.20 | 0.30 |
| Example 5 | | |

As can be seen from the data in Table 2, the precipitation coefficient of the Ganoderma lucidum compound preparation prepared by the method according to the present disclosure is significantly lower than that of the Ganoderma lucidum preparations prepared in comparative examples. Moreover, different processing sequences and steps also show an important impact on the stability of the product. In the present disclosure, γ-cyclodextrin is used to embed the active ingredients; natural polysaccharide colloids are used for outer microgel treatment; and the introduction of metal ions enhances acid resistance and heat resistance of the microgel, to achieve the best stabilization effect. The change of the sequence of treatment steps and the omitting of certain treatment step(s) would lead to a worse overall stability.

From the above examples and performance test results, it can be seen that: the Ganoderma lucidum compound preparation provided by the present disclosure is prepared from the superfine powder of the Ganoderma lucidum fruiting body instead of a single component or extract thereof, thereby retaining active ingredients of Ganoderma lucidum to the greatest extent. Moreover, the embedding and microgel processes during the preparation are conducive to the stable preservation of the active ingredients and improve the nutritional and active values of the product. Meanwhile, compared with Ganoderma lucidum products without a composite stabilizer, this Ganoderma lucidum compound preparation has a significantly improved retention level of active ingredients, with no bad flavor introduced. Therefore, the Ganoderma lucidum compound preparation is extremely suitable as a functional food (such as a beverage) for the full utilization of Ganoderma lucidum for daily nutritional supplementation.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for preparing a Ganoderma lucidum compound, comprising the steps of mixing a superfine powder of a Ganoderma lucidum fruiting body, γ-cyclodextrin, and a part of water to allow embedding to obtain a first feed liquid;
mixing the first feed liquid with a composite colloid stabilizer solution to obtain a second feed liquid, wherein a colloid stabilizer in the composite colloid stabilizer solution comprises at least three selected from the group consisting of agar, guar gum, locust bean gum, carrageenan, and xanthan gum;
mixing the second feed liquid with a metal ion solution to obtain a first mixture, and subjecting the first mixture to adjustment to acidic and shearing sequentially to obtain a third feed liquid, wherein metal ions in the metal ion solution comprise iron ions, calcium ions, or zinc ions; and
mixing the third feed liquid with remaining water to obtain a second mixture, and subjecting the second mixture to homogenization and heating sequentially to obtain the Ganoderma lucidum compound preparation.

2. The method of claim 1, wherein the superfine powder of the Ganoderma lucidum fruiting body has an average particle size of 2 μm to 5 μm, and the Ganoderma lucidum compound preparation comprises 3 wt % to 6 wt % of the superfine powder of the Ganoderma lucidum fruiting body.

3. The method of claim 1, wherein the Ganoderma lucidum compound preparation comprises 0.1 wt % to 0.2 wt % of the γ-cyclodextrin.

4. The method of claim 2, wherein the Ganoderma lucidum compound preparation comprises 0.1 wt % to 0.2 wt % of the γ-cyclodextrin.

5. The method of claim 1, wherein the embedding is conducted at a temperature of 50° C. to 60° C. for 40 min to 60 min under an ultrasonic treatment with an ultrasonic power of 300 W to 500 W.

6. The method of claim 1, wherein the Ganoderma lucidum compound preparation comprises 0.21 wt % to 0.69 wt % of the colloid stabilizer.

7. The method as claimed in claim 2, wherein the Ganoderma lucidum compound preparation comprises 0.21 wt % to 0.69 wt % of the colloid stabilizer.

8. The method of claim 1, wherein the metal ion solution is an aqueous solution of a food-grade metal salt additive; and the Ganoderma lucidum compound preparation comprises 0.02 wt % to 0.04 wt % of the food-grade metal salt additive.

9. The method as claimed in claim 2, wherein the metal ion solution is an aqueous solution of a food-grade metal salt additive; and the Ganoderma lucidum compound preparation comprises 0.02 wt % to 0.04 wt % of the food-grade metal salt additive.

10. The method as claimed in claim 1, wherein the part of water accounts for 50% to 60% of a total volume of the Ganoderma lucidum compound preparation; and the adjustment to acidic refers to adjusting a pH value of the first mixture to 4.1 to 4.2.

11. The method as claimed in claim 2, wherein the part of water accounts for 50% to 60% of a total volume of the Ganoderma lucidum compound preparation; and the adjustment to acidic refers to adjusting a pH value of the first mixture to 4.1 to 4.2.

12. The method as claimed in claim 1, wherein the shearing is conducted at a rotation speed of 3,000 rpm to 5,000 rpm for 15 min to 30 min;
the homogenization is conducted at a pressure of 20 MPa to 25 MPa for 5 min to 10 min; and
the heating is conducted at a temperature of 90° C. to 100° C. for 15 min to 30 min.

13. A Ganoderma lucidum compound preparation prepared by the method as claimed in claim 1.

14. A method for preparing a Ganoderma lucidum health beverage, comprising the step of using the Ganoderma lucidum compound preparation as claimed in claim 13.
